(19) United States
(12) Patent Application Publication
(10) Pub. No.: US 2005/0185825 A1
(43) Pub. Date: Aug. 25, 2005

(54) Table type information terminal

(76) Inventors: Takeshi Hoshino, Kodaira (JP); Youichi Horii, Mitaka (JP); Yukinobu Maruyama, Kokubunji (JP); Yoh Miyamoto, Tokyo (JP); Mariko Kato, Tokyo (JP); Manabu Yanagimoto, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/053,261

(22) Filed: Feb. 9, 2005

(30) Foreign Application Priority Data
Feb. 13, 2004 (JP) 2004-036745

(51) Int. Cl. G06K 9/00; G06K 9/52; G06K 9/68; G06K 9/36; G06K 9/48; H04N 7/18; H04N 5/225; H04N 5/228; H04N 5/232; H04N 9/09; H04N 5/268

(52) U.S. Cl. 382/103; 382/107; 382/236; 382/219; 382/199; 382/206; 382/286; 348/705; 348/211.9; 348/153; 348/159; 348/262; 348/552; 348/169; 348/208.14

(57) ABSTRACT

Projector units in a table display a content list, a content selected by the content list and the like, on screens. Infrared rays are uniformly irradiated to the screens from a plurality of infrared LED's. A camera unit images the silhouette of an object touching the screens to judge whether the silhouette is formed by a pointing member such as a fingertip for touching the content list or by an object other than the pointing member. If it is judged that the pointing member such as a fingertip touches the screens, a content menu is selected from the content list.

### CLAIM OF PRIORITY

The present application claims priority from Japanese application JP 2004-036745 filed on Feb. 13, 2004, the content of which is hereby incorporated by reference into this application.

### BACKGROUND OF THE INVENTION

The present invention relates to a table type information terminal for providing the content requested by a user from a screen mounted on the top board of a table.

There is a conventional method of providing a user with a desired content, by which a list of menus (content list) is displayed on the screen, a user selects a desired content from the content list, a server selects this content and displays it on the same screen.

One example of this method has been proposed, by which a content list is displayed on a screen by strolling it, for example, from the right to left on the screen (for example, refer to JP-A-2001-273298 (FIGS. 9 to 11).

In tea rooms, cafes, bars and the like, a display screen is mounted on the top board of a table, like a game machine, desired images such as video images are displayed on the screen to provide a user with images. It is conceivable that by introducing a content provision method described in the above-described Patent Document to such a table type information terminal, a user can be selectively provided with a desired content.

### SUMMARY OF THE INVENTION

If the method described in the above-described Patent Document is used for displaying images on the screen at a top board of a table, it is conceivable that a desired content can be made selectable by touching a desired content in a content list displayed on the table screen in order to make it easy for a user to handle the table type information terminal.

If a desired content is to be selected from a scrolling content list, a user is requested to touch the content with a fingertip and this touch is required to be detectable.

In a touch operation of selecting a content, a content is selected even if an object other than a fingertip such as a cup is placed on the table screen, and in addition, a portion of the content list is hidden with the placed object and a user cannot look at the portion of the content list. This problem may result in the fear that a user cannot use the terminal conveniently.

After a desired content is selected from the content list, the images of the selected content are displayed on the screen and the content list disappears. When a user desires to view another content, the user is required to change the content picture to the content list picture, resulting in a complicated operation. This complicated operation may also result in the fear that a user cannot use the terminal conveniently.

An object of this invention is to provide a table type information terminal capable of solving the above-described problems, allowing a user to use the terminal comfortably, and receiving a desired content easily and reliably.

In order to achieve the above object, the present invention provides a table type information terminal including: a control unit; a screen disposed on a table plane; a projector unit disposed on one side of the screen for projecting an image on the screen; and a camera unit disposed on one side of the screen for imaging a silhouette of an object formed on the screen, the object being on another side of the screen, wherein the control unit judges whether the silhouette imaged with the camera unit is a silhouette of a pointing member for selecting a portion of the projected image or a silhouette of an object other than the pointing member.

The silhouette of the pointing member is, for example, the silhouette of a fingertip, and the control unit judges through pattern recognition whether the silhouette imaged with the camera unit is a silhouette of a pointing member for selecting a portion of the projected image or a silhouette of an object other than the pointing member.

The present invention further provides a table type information terminal including: a control unit; a screen disposed on a table plane; a projector unit disposed on one side of the screen for projecting an image on the screen; and a camera unit disposed on one side of the screen for imaging a silhouette of an object formed on the screen, the object being on another side of the screen, wherein: the projector unit displays in a scrolling and flowing manner a content list including a plurality of content menus on the screen; and the control unit judges whether the silhouette imaged with the camera unit is a silhouette of a pointing member for selecting a portion of the projected image or a silhouette of an object other than the pointing member, and if it is judged that the silhouette is the silhouette of the object other than the pointing member, controls a flow of the content list to display the content list to flow by avoiding the object.

The present invention further provides a table type information terminal including: a control unit; a screen disposed on a table plane; a projector unit disposed on one side of the screen for projecting an image on the screen; a camera unit disposed on one side of the screen for imaging a silhouette of an object formed on the screen, the object being on another side of the screen; and a tag reader unit for reading an IC tag or a card reader unit for reading an IC card, wherein: the control unit makes the projector unit project an image on the screen in accordance with information read from the ID tag with the tag reader unit or information read from the IC card with the card reader unit; and the control unit judges whether the silhouette imaged with the camera unit is a silhouette of a pointing member for selecting a portion of the projected image or a silhouette of an object other than the pointing member.

Other objects, features and advantages of the invention will become apparent from the following description of the embodiments of the invention taken in conjunction with the accompanying drawings.

### BRIEF DESCRIPTION OF THE DRAWINGS

FIGS. 1A, 1B and 1C are diagrams showing a table type information terminal according to an embodiment of the present invention.

FIGS. 2A to 2H are diagrams explaining the effects of infrared ray irradiation from infrared LED's shown in FIGS. 1A to 1C.

FIG. 3 is a diagram showing area sections of a display area of a screen shown in FIGS. 1A to 1C.

FIGS. 4A and 4B are diagrams showing a silhouette and a content menu flow while a content display area shown in FIG. 3 is touched with a fingertip.

FIGS. 5A and 5B are diagrams showing a silhouette while an object other than a finger tip is placed on the content list display area shown in FIG. 3.

FIGS. 6A and 6B are diagrams showing a content menu flow corresponding to the silhouette shown in FIG. 5B.

FIG. 7 is a diagram showing the internal structure of the first embodiment shown in FIGS. 1A to 1C and a system using the first embodiment.

FIGS. 8A, 8B and 8C are schematic diagrams showing each database shown in FIG. 7.

FIG. 9 is a flow chart illustrating an example of the overall operation of the first embodiment shown in FIGS. 1A to 1C.

FIGS. 10A and 10B are diagrams showing examples of a standby picture and an operation explanation picture according to the first embodiment shown in FIGS. 1A to 1C.

FIGS. 11A to 11E are diagrams showing a portion of an example of transition of an automatic information operation picture on the screen shown in FIGS. 1A to 1C.

FIGS. 12A to 12D are diagrams showing transition of the automatic information operation picture following FIGS. 11A to 11E.

FIGS. 13A to 13D are diagrams showing transition of the automatic information operation picture following FIGS. 12A to 12D.

FIGS. 14A to 14D are diagrams showing transition of the automatic information operation picture following FIGS. 13A to 13D.

FIGS. 15A to 15C are diagrams showing a portion of an example of transition of an information operation picture on the screen shown in FIGS. 1A to 1C while using a wireless ID tag.

FIGS. 16A to 16E are diagrams showing a portion of an example of transition of the information operation picture on the screen shown in FIGS. 1A to 1C while using the wireless ID tag.

FIGS. 17A to 17D are diagrams showing transition of the information operation picture following FIGS. 16A to 16E.

FIGS. 18A to 18D are diagrams illustrating an example of an operation method for the information operation picture on the screen shown in FIG. 1A to 1C.

FIGS. 19A to 19L are diagrams illustrating another example of an operation method for the information operation picture on the screen shown in FIG. 1A to 1C.

FIG. 20 is a perspective view showing the outer appearance of the main part of a table type information terminal according to a second embodiment of the present invention.

### DESCRIPTION OF THE EMBODIMENTS

Embodiments of the invention will be described with reference to the accompanying drawings.

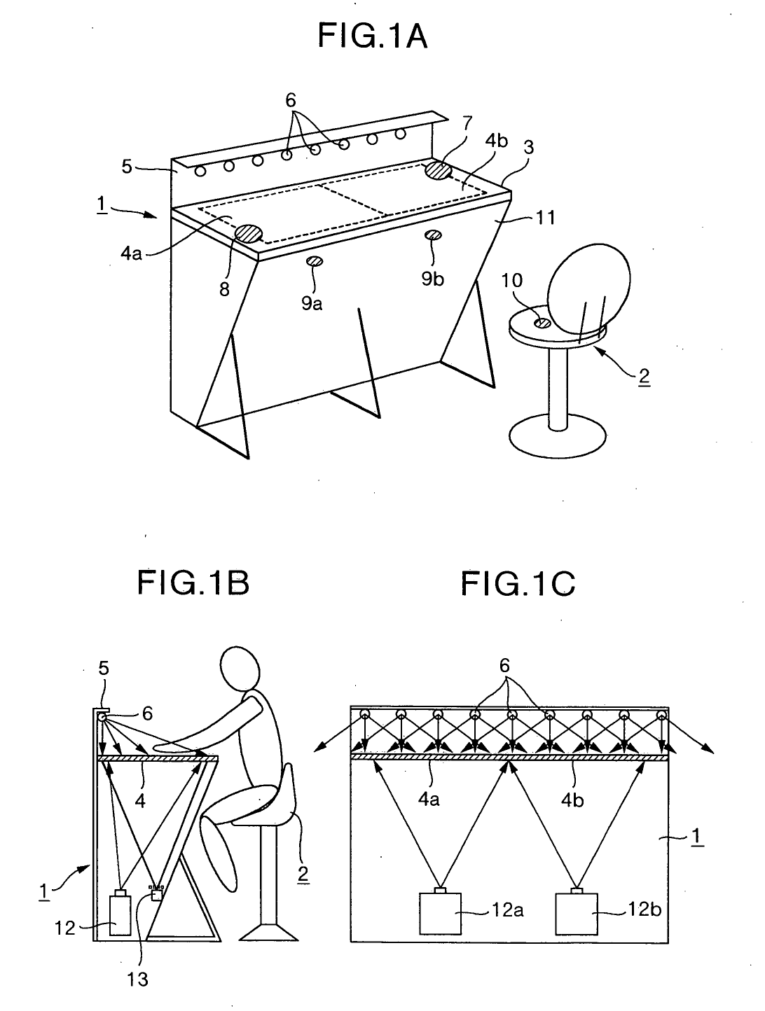

FIGS. 1A to 1C are diagrams showing the structure of an information display terminal according an embodiment of the present invention. FIG. 1A is a perspective view showing the outer appearance of the terminal, FIG. 1B is a vertical cross sectional view along a depth direction, and FIG. 1C is a vertical cross sectional view along a lateral direction. In FIGS. 1A to 1C, reference numeral 1 represents a table, reference numeral 2 represents a chair, reference numeral 3 represents a table plane, reference numerals 4, 4a and 4b represent a screen, reference numeral 5 represents a partition, reference numeral 6 represents an infrared light emitting diode (LED), reference numeral 7 represents a tag reader for a wireless ID tag, reference numeral 8 represent a card reader for a wireless IC card, reference symbols 9a and 9b represent a contact-less sensor, reference numeral 10 represents a sitting sensor, reference numeral 11 represents a front panel, reference numeral 12 represents a projector unit, and reference numeral 13 represents a camera unit.

Referring to FIGS. 1A to 1C, the embodiment is constituted of the table 1 and the chair 2 on which a user sits down in front of the table 1. The chair 2 is placed at a fixed position relative to the table 1.

On the upper plane of a laterally elongated top board of the table 1, i.e., on the table plane 3, screens 4a and 4b are juxtaposed on nearly the whole table plane 3. Touch sensors (not shown) are mounted on these screens 4a and 4b to provide a touch panel function. In this embodiment, although two screens 4a and 4b are used, one screen or three or more screens may be used. A partition 5 is mounted on the side of the table plane 3 opposite to the chair (hereinafter called a back side, and the chair 2 side is called a front side), nearly over the whole side. A plurality of infrared LED's are mounted on the partition 5 along the juxtaposed direction of the screens 4a and 4b. The infrared LED's irradiate infrared rays to the screens 4a and 4b at generally a uniform intensity in the whole screen area.

At the right end portion of the table plane 3, the tag reader 7 is mounted for reading a wireless ID tag, and at the left end portion of the table plane 3, the card reader 8 is mounted for reading a wireless IC card. The tag reader 7 and card reader 8 are mounted on the areas inside the table plane 3. As a wireless ID tag is placed approximately at the position of the table plane 3 where the tag reader 7 is mounted, the wireless ID tag is read with the tag reader 7. Similarly, as a wireless IC card is placed approximately at the position of the table plane, 3 where the card reader 8 is mounted, the wireless IC card is read with the card reader 8.

The contact-less sensors 9a and 9b for detecting a user (customer) coming near to the table 1 are mounted on the front panel 11 of the table 1, and the sitting sensor 10 is mounted on the chair 2 at the position where a user sits down.

As shown in FIG. 1B, the projector 12 and camera unit 13 are mounted in the table 1. An image taken with the projector is magnified by a lens (not shown) and projected upon the screen 4. The camera unit 13 photographs the screen 4 from the rear side via an unrepresented infrared filter, the screen 4 being irradiated with infrared rays from the infrared LED's 6, and detects a silhouette of an object such as a fingertip placed on the screen 4. This photographed silhouette is subjected to a pattern recognition process to judge the kind, motion direction and the like of the silhouette object on the screen 4.

As shown in FIG. 1C, each infrared LED 6 irradiates an infrared ray at a wide angle to overlap the irradiation areas of adjacent infrared LED's 6. In this embodiment, two projector units 12a and 12b are provided as the projector unit 12, the projector unit 12a projects an image upon the screen 4a and the projector unit 12b projects an image upon the screen 4b. Although not shown in FIG. 1C, it is assumed herein that two camera units 13 (FIG. 1B) are used.

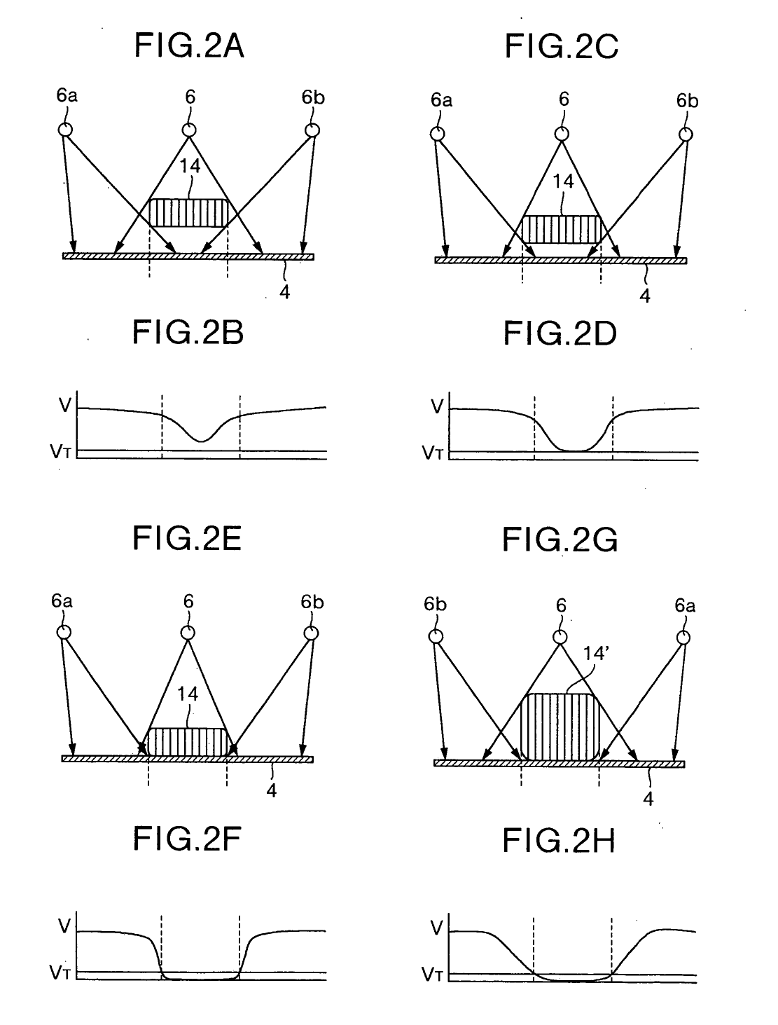

With reference to FIGS. 2A to 2H, description will be made on the operation of wide angle irradiation of an infrared ray by each infrared LED 6.

FIGS. 2A, 2C and 2E show the illumination states of infrared rays (indicated by an arrow) of objects 14 at different distances from the plane of the screen 4. The objects 14 come nearer to the screen 4 in the order of FIGS. 2A and 2C, and the object 14 is placed on the screen 4 in FIG. 2E.

FIGS. 2A, 2D and 2F show video signals picked up with the camera unit 13 in the states shown in FIGS. 2A, 2C and 2E.

As shown in FIG. 2A, in the state that the object 14 is at the position away from the screen 4, an infrared ray irradiated at a wide angle from the infrared LED 6 just above the object 14 is irradiated to the upper surface of the object 14 and will not be irradiated to the sides and bottom surface of the object 14. However, infrared rays irradiated at a wide angle from the positions shifted from just above the object 14, e.g., from the adjacent infrared LED's 6a and 6b, enter the space under the bottom of the object 14. Consequently, as shown in FIG. 2B, a video signal picked up with the camera unit 13 has a lowered level V in the area of the object 14, the lowered level V having some level.

As shown in FIG. 2C, in the case that the object 14 comes nearer to the screen 4 than the state shown in FIG. 2A, the light amount of infrared rays entering the space under the bottom of the object 14 from the adjacent infrared LED's 6a and 6b reduces and the silhouette of the object 14 on the screen 4 becomes dense, and the level V of the video signal further lowers correspondingly in the area of the object, as shown in FIG. 2D. The differential values of the level V in a spatial direction at the edge portions where the level V lowers (portions where the level lowers or rises, hereinafter called a lowered level boundary portion), become larger than those of FIG. 2A. The differential value becomes larger as the object 14 comes nearer to the screen 4.

As shown in FIG. 2E, in the state that the bottom of the object 14 contacts the screen 4 and is placed on the screen 4, since there is no infrared ray entering the space under the object 14, the level V of the video signal in this area becomes almost zero as shown in FIG. 2F, and the differential values of the lowered level boundary portion toward the level V=0 become larger than those of FIG. 2D, as seen from FIG. 2F. As shown in FIGS. 2B to 2F, a threshold value of a level V_{T} near the level V=0 is set and compared with the level of a video signal. If the object 14 contacts the screen 4 as shown in FIG. 2E, the level V of the video signal in this area becomes V<V_{T} as shown in FIG. 2F.

In this manner, whether the object 14 is coming near to or moving away from the screen 4 can be judged from a change in the differential values of the video signal in the lowered level boundary portion. It is also possible to judge from the threshold value of V_{T} near the level V=0 whether the object 14 is placed on the screen 4.

As shown in FIG. 2G, in the state that an object 14′ is placed on the screen 4 which object has the same thickness as the object 14 and a different height, as apparent from the comparison with FIG. 2E, a light amount of infrared rays irradiated to the peripheral area of the higher object 14′ on the screen 4 is smaller. Therefore, the differential values in the lowered level boundary portion are smaller for the higher object 14′ as apparent from the comparison with FIG. 2E. It is therefore possible to presume from this the height degree whether the object on the screen 4 is high or low.

The area size of a cross section and the shape of the bottom of an object placed on the screen 4 can be judged from the size and shape of the silhouette on the screen 4, and the position of the silhouette on the screen 4 can be judged.

As described above, by using the infrared LED's 6 emitting infrared rays at a wide angle, the above-described information of the object 14 can be judged and presumed in accordance with the silhouette of the object 14.

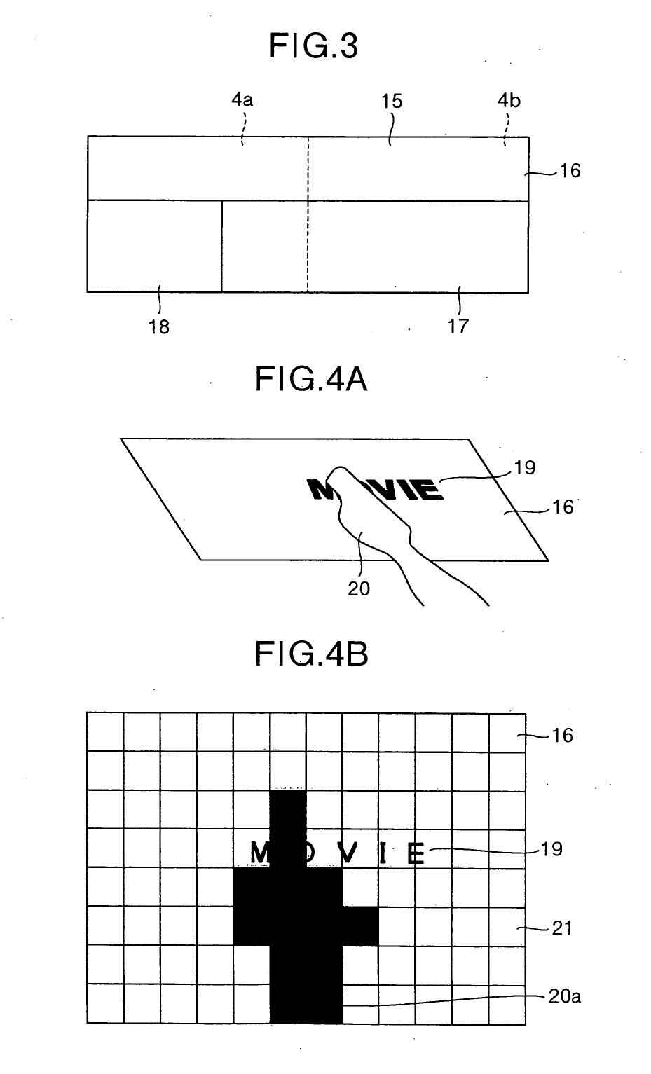

FIG. 3 is a diagram showing display area sections of the information operation picture 15 displayed on the screens 4a and 4b shown in FIGS. 1A to 1c.

Referring to FIG. 3, the information operation picture 15 is displayed on the screens 4a and 4b, and allows a user to perform an operation of acquiring a content (a vertical broken line indicates a boundary between the screens 4a and 4b). The information operation picture is divided into: a laterally elongated content list display area 16 occupying the whole lateral length of the information operation picture 15 and positioning in the upper area of the information operation picture 15; a laterally elongated content reproduction area 17 occupying a portion of the lateral length of the information operation picture 15 and positioning in the lower area of the information operation picture 15; and a content storage area 18 occupying the remaining lower area of the information operation picture 15. Displayed in the content list display area 16 is a list of content menus (i.e., a content list) of a character string which is scrolled sequentially, for example, from the right to left. As a desired content menu is touched with a pointing member such as a fingertip, the content corresponding to the desired content menu is reproduced from a database (not shown) and displayed in the content reproduction area 17. If the content reproduced and displayed in the content reproduction area 17 is touched, for example, with a fingertip and moved to the content storage area 18, the content can be stored in an IC card (not shown) by the card reader 8 (FIG. 1A) or can be transferred to a personal computer (PC) or the like possessed by a customer.

If the content display area 16 is touched with the pointing member such as a finger tip in the above-described scroll display state of the content list in the content list display area 16, the flow state of the content list will not change. However, for example, if the information display terminal of the embodiment is installed in a tea shop, a bar or the like and an object such as a cup different from the pointing member such as a finger tip is placed on the information operation picture 15 on the table plane 3, the content list flows running away from the object as if water flows moving away from an obstacle in a river. It is therefore possible to judge whether the object forming a silhouette is the pointing member such as a finger tip, by recognizing the pattern of the shape of the silhouette on the screens 4a and 4b picked up with the camera unit 13 (FIG. 1B).

As shown in FIG. 4A, as a content menu 19 “MOVIE” flowing in the content list display area 16 is touched with the pointing member such as a fingertip of a hand 20, as shown in FIG. 4B showing the enlarged display area of the content menu 19, a silhouette 20a of the hand 20 is displayed on the screens 4 (4a and 4b). For example, in order to recognize the pattern of a silhouette, the screen 4 is virtually divided into small unit areas (hereinafter called cells) 21. In accordance with the layout of such cells 21 contained in the silhouette 20a, the shape of the silhouette, hence the type of the object forming the silhouette 20a, i.e., the hand 20 or another object, is judged. In this example, since the content menu 19 is touched with a fingertip, the silhouette 20a is judged as a silhouette of the hand 20 and the content menu 19 continues to scroll (flow) in the same direction.

In this example, since the content menu “MOVIE” 19 is touched, the corresponding content is displayed in the content reproduction area 17 (FIG. 3). A contact of the hand 20 with the screen 4 in the silhouette 20a can be detected by the method using the threshold value V_{T} described with reference to FIGS. 2E and 2F and FIGS. 2G and 2H.

The size of a cell 21 is set to a size accommodating one character constituting the content menu 19 (e.g., 8×8 pixels), and the position of each cell 21 on the screen 2, i.e., in the content list display area 16, is managed. Therefore, the position of a silhouette in the content display area 16 is detected in correspondence with the positions of cells 21, and the position of each character constituting the content menu scrolling in the content display area 16 is also managed in correspondence with the positions of cells 21. In this manner, the position of a detected silhouette and the position of each character of the content list are managed.

A video signal from the camera unit 13 is converted into a digital video signal and thereafter binarized by using the threshold value V_{T} so as to make the pixel value having a level equal to or smaller than the threshold value V_{T} have a value “0”. If the percentage of the number of pixels having the value “0” in a cell is a predetermined value (e.g., 20%), it is judged that this cell is in the silhouette.

The position of each cell is identified by the position of, for example, an upper left corner pixel of this cell. Therefore, the position of a cell at a horizontal m-th position and a vertical n-th position in the unit of pixel position on the screens 4a and 4b having cells 21 shown in FIG. 4B each constituted of 8×8 pixels, is represented by {(1+8(m−1), (1+8(n−1)}.

Each content menu 19 moves in such a manner that along a track (an ordinary lateral track) on which a top character (character “M” in the content menu 19 shown in FIGS. 4A and 4B) moves, i.e., following the top character, the remaining characters (characters “O”, “V”, “I”, and “E”) move. It is judged whether or not the cell one position before the cell, along the cell motion direction, in which the top character is contained, is contained in the silhouette. If the forward cell is not contained in the silhouette or even if the forward cell is contained in the silhouette of the pointing member such as a fingertip, the top character and remaining characters move toward the forward cell. In this manner, in the cell area not contained in the silhouette, the content menu moves along the ordinary lateral direction.

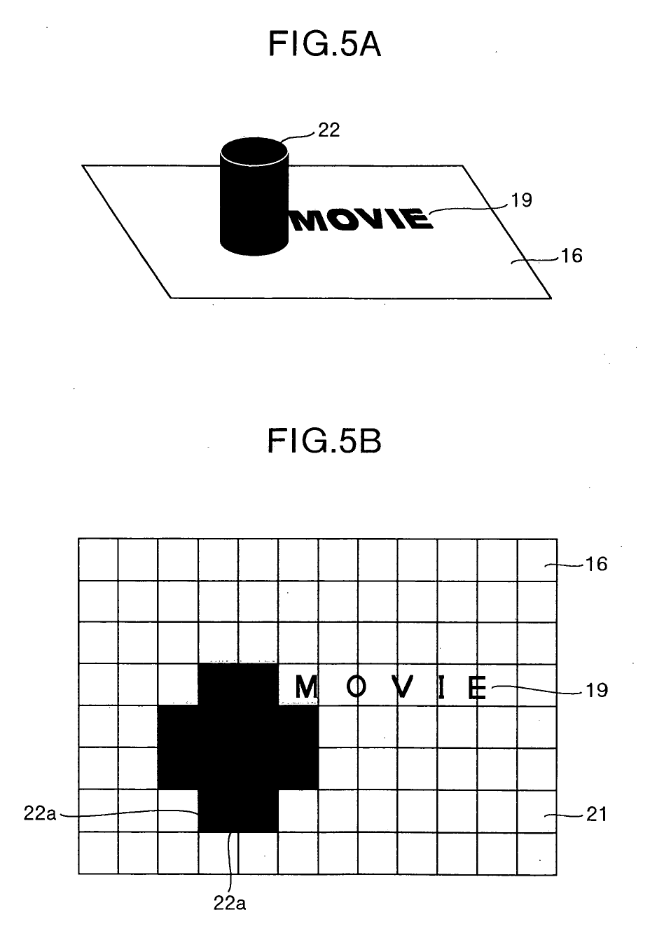

As shown in FIG. 5A, if an object 22 such as a cup different from the pointing member such as a fingertip is placed in the content display area 16 in which the content list is scrolled, a silhouette 22a of the cup takes a shape shown in FIG. 5B. It can therefore recognize through pattern recognition that the object is different from the pointing member such as a fingertip.

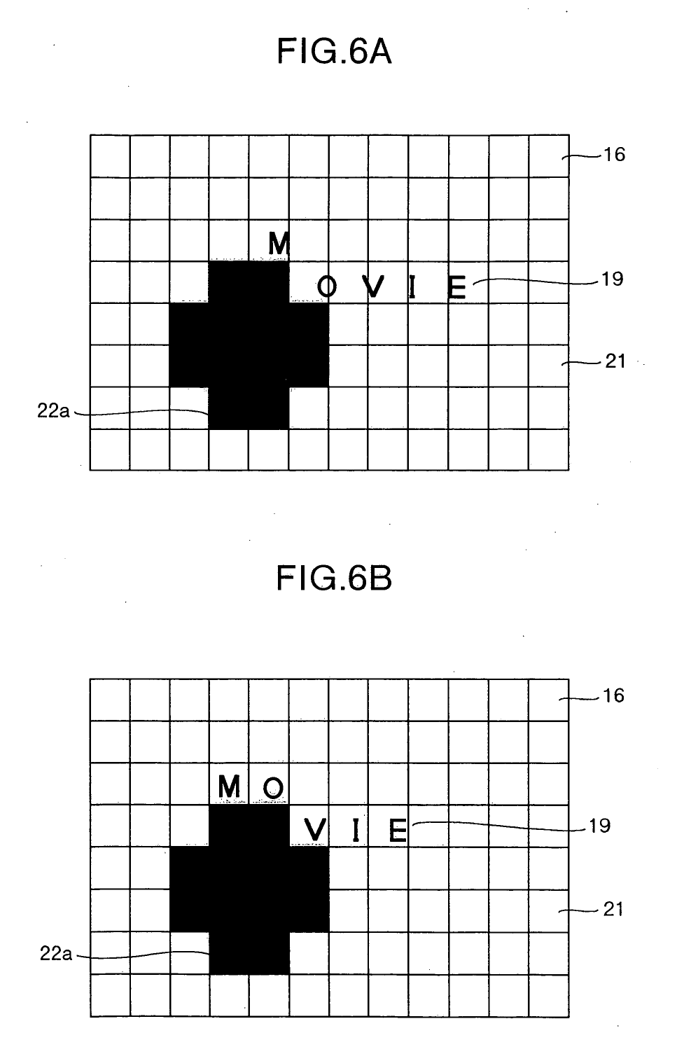

In this case, as the content menu “MOVIE” 19 flows as if it collides with the silhouette 22a and when it is judged that it is the time immediately before the content menu collides with the silhouette 22a, i.e., that the cell one position before the top character “M” of the content menu “MOVIE” is contained in the silhouette 22a, then as shown in FIG. 6A the top character “M” changes its motion direction to a direction (e.g., an up direction) to avoid collision with the silhouette 22a. Thereafter, as shown in FIG. 6B, the next character “O” also changes its motion direction to the same direction to avoid collision with the silhouette 22a. In this manner, the characters of the content menu “MOVIE” 19 sequentially change the motion direction to the direction to avoid collision with the silhouette 22a. When the content menu reaches the position where collision is avoided in the ordinary direction, the ordinary direction (i.e., the longitudinal direction of the content list display area 16) is recovered. Depending upon the shape of the silhouette 22a, there is the case that even after the direction is changed, the content menu collides with the silhouette. In this case, the motion direction is again changed to avoid the collision. There is therefore the case that the direction is reversed once.

The direction of the flow of the content menu relative to the silhouette is determined by a predetermined rule. For example, when it is detected that the cell one position before the current cell containing the top character is contained in the silhouette, it is first judged whether the cell one position upper than the current cell is contained in the silhouette. If it is not contained, the motion direction is changed toward the subject cell, whereas if it is contained, it is judged whether the cell one position lower than the current cell is contained in the silhouette. With these judgements, the content menu 19 flows avoiding collision with an object different from the pointing member such as a fingertip. The remaining characters of the content menu following the top character also move along the track of the top character.

In the manner described above, when a silhouette of an object other than the pointing member such as a fingertip is detected, the content menu flows avoiding collision with this silhouette. Therefore, the list of content menus can be displayed and flowed without being hindered by the silhouette, i.e., without being hidden even if an object such as a cup is placed on the screen 4 on the table plane 3. The flow of a content list is similar to the flow of water in a river, and specific as different from a conventional menu list display method. Therefore, a customer has considerable interest and pays attention, increasing the use of such a menu list.

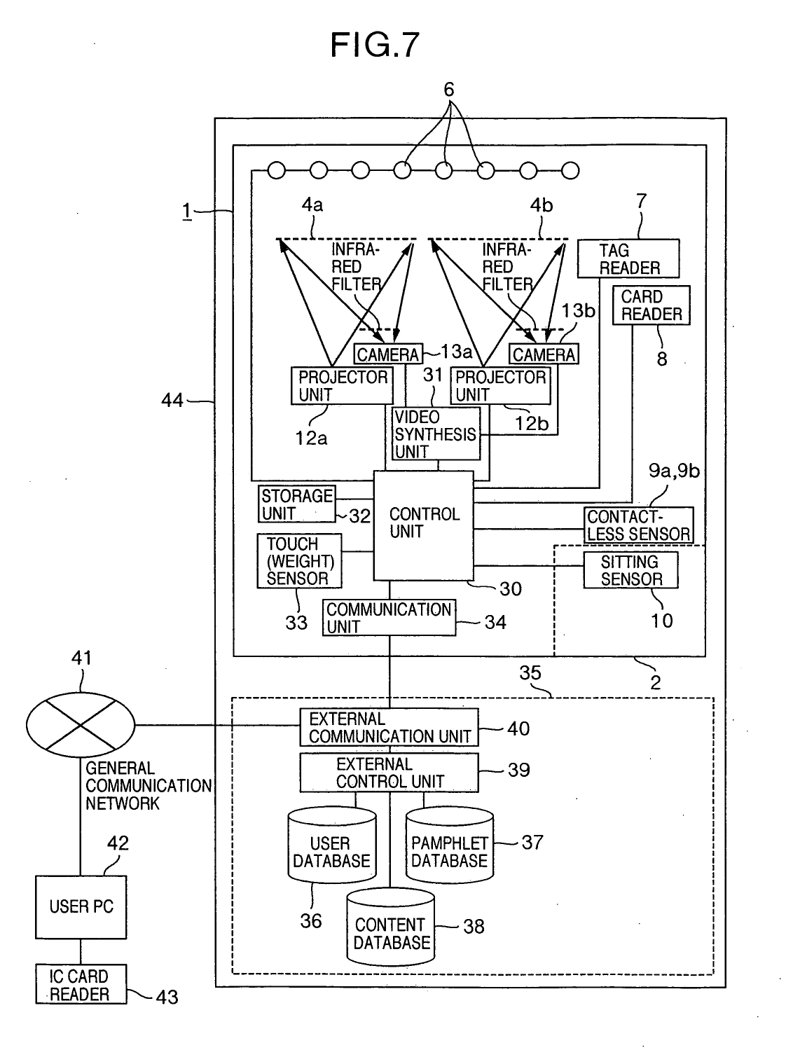

FIG. 7 is a diagram showing an example of the structures of the first embodiment and a system using the first embodiment. In FIG. 7, reference numeral 30 represents a control unit, reference numeral 31 represents a video synthesis unit, reference numeral 32 represents a storage unit, reference numeral 33 represents a touch sensor, reference numeral 34 represents a communication unit, reference numeral 35 represents a server, reference numeral 36 represents a user database, reference numeral 37 represents a pamphlet database, reference numeral 38 represents a content database, reference numeral 39 represents an external control unit, reference numeral 40 represents an external communication unit, reference numeral 41 represents a communication network, reference numeral 42 represents a personal computer (PC), and reference numeral 43 represents an IC card reader. Components corresponding to those shown in FIGS. 1A to 1C are represented by identical reference numerals and the duplicate description thereof is omitted. Although the touch sensor 33 is shown, this is used in the second embodiment and is not used in the first embodiment.

Referring to FIG. 7, video signals from the camera units 13a and 13b are supplied to the video synthesis unit 31 whereat the video signals are synthesized to generate a video signal for the whole information operation picture 15 (FIG. 3) on the screens 4a and 4b and supply it to the control unit 30. To this end, for example, the camera unit 13a picks up an image on the screen 4a during a half field period, and the camera unit 13b picks up an image on the screen 4b during the next half period. In this manner, the camera units 13a and 13b pick up images on the screens 4a and 4b for each field. The video synthesis unit 31 stores video signals of each field supplied from the camera units 13a and 13b and synthesizes them to generate images of the information operation picture 15 and supply them to the control unit 30.

The control unit 30 has a central processing unit (CPU) and the like, and controls each component and processes signals by using the storage unit 32. The control unit manages the position of each lower level cell 21 (FIG. 4B) on the information operation picture 15. The control unit processes the video signal from the video synthesis unit 31 to detect a silhouette on the screens 4a and 4b by the above-described method, and judges the position and shape of the silhouette by using the information of cells 21 containing the silhouette.

The video synthesis unit 31 is not necessarily required, but the video signals from the camera units 13a and 13b may be supplied directly to the control unit 30.

As the tag reader 7 reads tag information (in this case, a pamphlet ID) from a user wireless tag, the control unit 30 fetches the tag information or pamphlet ID. As will be later described, in accordance with information supplied from the server 35, the control unit 30 creates a content list corresponding to the pamphlet ID and supplies it to the projector units 12a and 12b to make them display the content list in the content list display area 16 (FIG. 3) of the information operation picture 15. In accordance with the silhouette detected from the video signals from the video synthesis unit 31, the control unit 30 controls the flow (scroll) of the content menu 19 in the content list display area 16, as described with reference to FIGS. 4A to 6B.

As the card reader 8 reads a user ID from a user wireless IC card, the control unit 30 fetches it. As will be later described, in accordance with information supplied from the server 35, the control unit 30 creates a content menu corresponding to the user ID and supplies it to the projector unit 12a to make it display the content menu in the content storage area 18 (FIG. 3) of the information operation picture 15. The control unit 30 reads from the server 35 the content selected from the content list displayed in the content list display area 16 and content menu displayed in the content storage area 18, and stores it in the storage unit 32. The control unit supplies the content to the projector units 12a and 12b to make them display the content in the content reproduction area 17 (FIG. 3) of the information operation picture 15. The communication with the server 35 is performed by using the communication unit 34.

The control unit 30 fetches outputs of the contact-less sensors 9a and 9b and the sitting sensor 10 to control each component.

The server 35 has the external communication unit 40 so that it can communicate with the user PC 42 and the like via the control unit 30 of the table 1 and the communication network 41. The server also has the user database 36, pamphlet database 37 and content database 38 so that it can supply the information of a content list and contents in response to a request from the control unit 30 of the table 1.

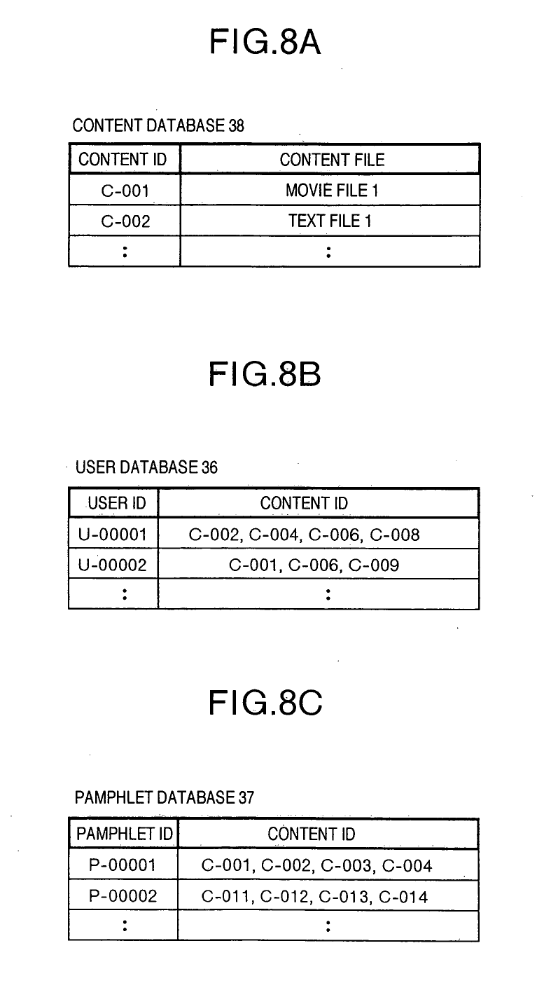

As shown in FIG. 8A, the content database 38 stores files such as a movie file and a text file added with a unique content ID.

A wireless IC card stores a unique ID (user ID). As shown in FIG. 8B, the user database 36 stores a content ID of the contents capable of being supplied from the content database 38 by using the user ID of the wireless IC card. For example, for a user ID “U-00001”, the contents of the content ID's “C-002”, “C-004”, “C-006” and “C-008” can be supplied. In accordance with the content ID, the control unit 30 creates the content list for the wireless ID card read with the card reader 8, and displays it in the content list display area 16 of the information operation picture 15.

The wireless ID tag stores its unique ID (pamphlet ID). As shown in FIG. 8C, the pamphlet database 37 stores ID's (content ID's) of contents capable of being provided from the content database 38 by using the pamphlet ID, for each pamphlet ID of a wireless ID tag. For example, for the pamphlet ID “P-00001”, the contents corresponding to the content ID's “C-001”, “C-002”, “C-003”, and “C-004” can be provided. In accordance with the content ID's, the control unit 30 generates a content list for the wireless ID tag read with the tag reader 7, and displays it in the content list display area 16 of the information operation picture 15.

Assuming that as the tag reader 7 reads the user wireless ID tag, the read pamphlet ID is “P-00001”, the control unit 30 sends the pamphlet ID to the server 35 via the communication unit 34. In the server 35, the external communication unit 40 receives the pamphlet ID and supplies it to the external control unit 39. The external control unit 39 executes an input information judgement process, and if it is judged that the input information is the pamphlet ID, reads the contents ID's “C-001”, “C-002”, “C-003”, and “C-004” corresponding to the pamphlet ID “P-00001” from the pamphlet database 37 and transmits the content ID's to the table 1 via the external communication unit 70. Upon reception of the content ID's, the communication unit 34 of the table 1 sends them to the control unit 30. As described above, the control unit 30 stores the received content ID's “C-001”, “C-002”, “C-003” and “C-004” in the storage unit 32, creates the content list corresponding to the content ID's, supplies it to the projector units 12a and 12b and displays the flowed (scrolled) content list in the content list display area 16 (FIG. 3) of the information operation picture 15. As the user selects a content menu from the content list, the content of the selected content menu is read from the content database 38 of the server 35 and displayed in the content reproduction area 17 (FIG. 3) of the information operation picture 15.

Also for the user ID read from the wireless IC card with the card reader 8, the control unit 30 reads the content ID's corresponding to the user ID from the user database 36 of the server 35, creates content menus corresponding to the content ID's, supplies them to the projector units 12a and 12b, and displays them in the content storage area 18 (FIG. 3) of the information operation picture 15. As the user selects one of the content menus, the content corresponding to the selected content menu is read from the content database 38 of the server 35 and displayed in the content reproduction area 17 (FIG. 3) of the information operation picture 15.

The external communication unit 40 of the server 35 is connected to the user PC 42 via the communication network 41 so that communications between the server 35 and PC 42 are possible. PC 42 has a card reader 43 for wireless cards. The user ID of a wireless card capable of being read with the card reader 8 of the table 1 is read, the content ID (FIG. 8B) corresponding to the user ID is fetched from the user database 36 of the server 35, and a list of content menus is displayed on the display screen of PC 42. By selecting a desired content menu from the list, the content corresponding to the selected content menu is fetched from the content database 38 of the server 35 and displayed on the display screen of PC 42. Namely, by using the wireless IC card used at the table 1, PC 42 can acquire the content of the content database 38 of the server 35.

The server 35 may be installed in the same building 44 (e.g., a shop such as a tea shop and a exhibition room), it may be connected to the table 1 via a network such as the Internet, or it may be installed in the table 1.

Next, description will be made on the operation of the first embodiment constructed as above.

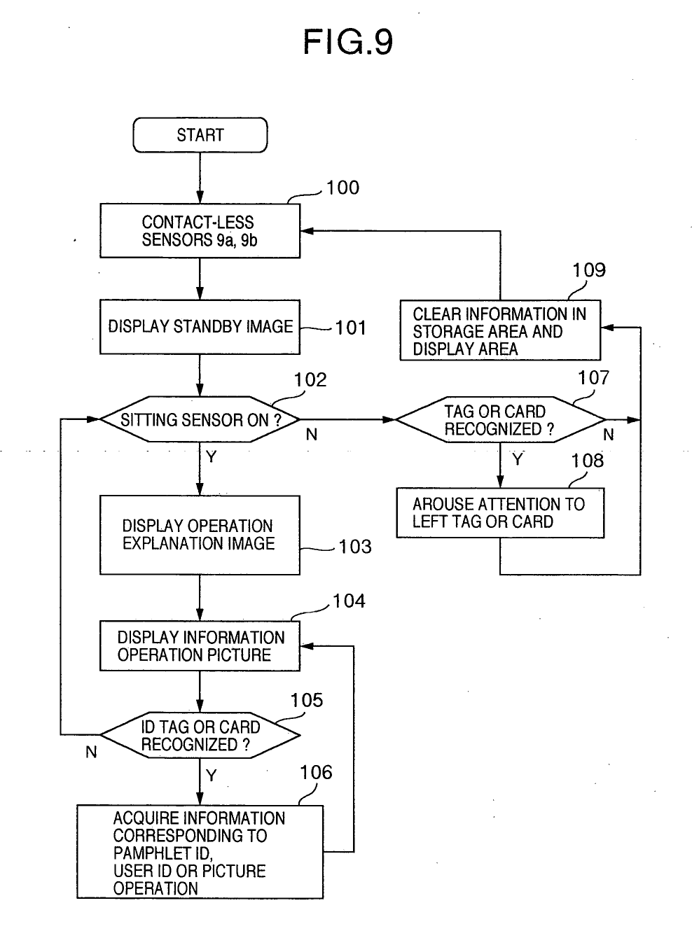

FIG. 9 is a flow chart illustrating the overall operation of the first embodiment.

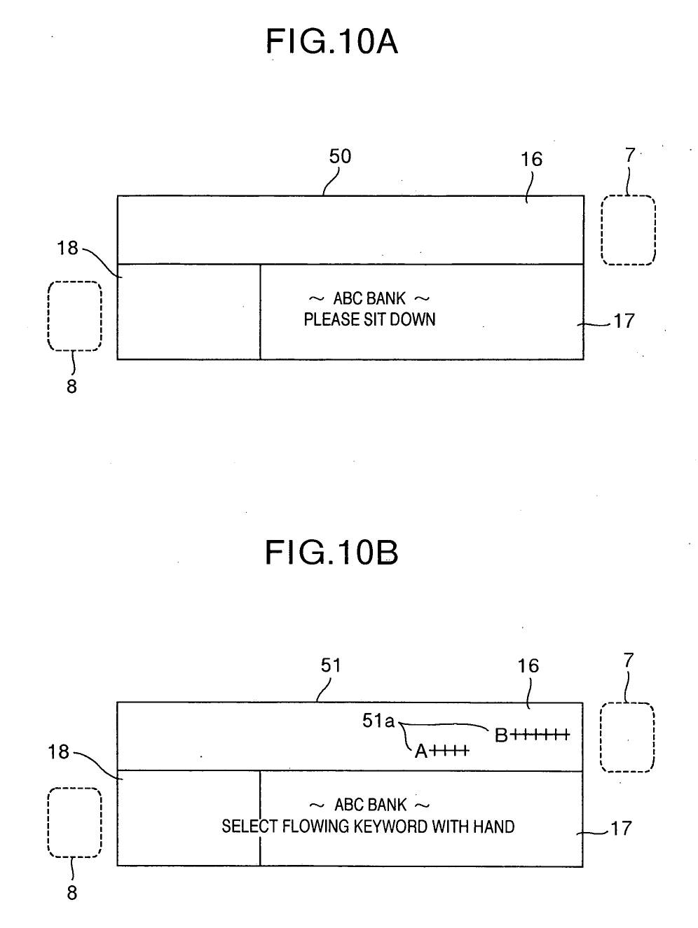

If a user (customer) does not come near to the table 1 shown in FIG. 1A and the contact-less sensors 9a and 9b do not detect any user, no image is displayed on the screens 4a and 4b. As a user comes near to the table and the contact-less sensors 9a and 9b detect this (Step 100 in FIG. 9), the control unit 30 (FIG. 7) operates to display a standby image 50 (FIG. 10A) on the screens 4a and 4b (Step 101 in FIG. 9). For example, as the standby image 50, only a guide message such as “Please sit down” is displayed. As the user sits down on the chair 2, following this guide, this sitting is detected (Step 102 in FIG. 9) an the operation explanation picture 51 (FIG. 10B) is displayed on the screens 4a and 4b (Step 103 in FIG. 9). Although the detailed description is omitted, the operation explanation picture 51 explains the operation method for an information operation picture to be displayed at the next Step 104 in FIG. 9. For example, following a guide message such as “Select flowing keyword”, a desired keyword 51a displayed flowing in the content list display area 16 of the operation explanation picture 51 is touched and then the picture is changed to the information operation picture 15 (FIG. 3) with which a content browsing operation described above can be performed (Step 104 in FIG. 9).

The information operation picture 15 includes: an information operation picture to be used when the tag reader 7 reads the pamphlet ID from a wireless ID tag; an information operation picture to be used when the card reader 8 reads the user ID from a wireless IC card; and an automatic information operation picture which is automatically displayed when the pamphlet ID and user ID are not read.

As the user sits down on the chair 2 and operates the operation explanation picture 51, the automatic operation picture is displayed. By operating this automatic operation picture, it is possible to acquire the content corresponding to the content list displayed in the content list display area 16 of the automatic information operation picture, from the content database 38 of the server 35, and to display it in the content reproduction area 17.

As the tag reader 7 reads the pamphlet ID of a wireless ID tag or the card reader 8 reads the user ID of a wireless IC card, during the display of the automatic information operation picture (Step 105 in FIG. 9), the content ID corresponding to the pamphlet ID or user ID is read from the server 35 (Step 106 in FIG. 9), and the information operation picture displaying such information is displayed in the information operation picture 15.

While the information operation picture is displayed, the control unit 30 fetches generally periodically a detection output of the sitting sensor 10 (Step 102 in FIG. 9). When the user stands up from the chair 2, a process of recognizing whether the wireless ID tag is left in the tag reader 7 and a process of recognizing whether the wireless IC card is left in the card reader 7, are executed (Step 107 in FIG. 9). If neither the wireless ID tag nor the wireless IC card is left, the information in the information operation picture is erased (Step 109 in FIG. 9), or if one of them is left, this effect is notified to the user by using voices or the like (Step 108 in FIG. 9) and thereafter, the information in the information operation picture is cleared (Step 109 in FIG. 9). It stands by until another user comes near to the table (Step 100 in FIG. 9).

As the sitting sensor 10 detects that a user goes away from the chair 2, the display image on the screens 4a and 4b is cleared so that the history of the picture operation made previously is refreshed.

Description will be made on the wireless ID tag and wireless IC card. For example, since the contents of the same genre can be browsed by using the same wireless ID tag, the genre of the contents capable of being browsed may be changed for each wireless ID tag. For example, if the content of a sport genre is desired, the wireless ID tag of this genre is used. If the table 1 is installed in a shop such as a tea shop, the shop may rent such a wireless ID tag.

A wireless IC card allows a user to browse a desired content regardless of the genre. As will be later described, by using the wireless IC card, the contents capable of being browsed with the wireless IC card can be selected from the content list displayed in the content list display area 16 of the information operation picture 15.

In the above-described automatic information operation picture, the content may be a recommended content, a promotion and advertisement content of a shop, a commercial content of another company or the like.

Next, description will be made on the information operation picture 15 of the first embodiment.

(1) Automatic Information Operation Picture 15a:

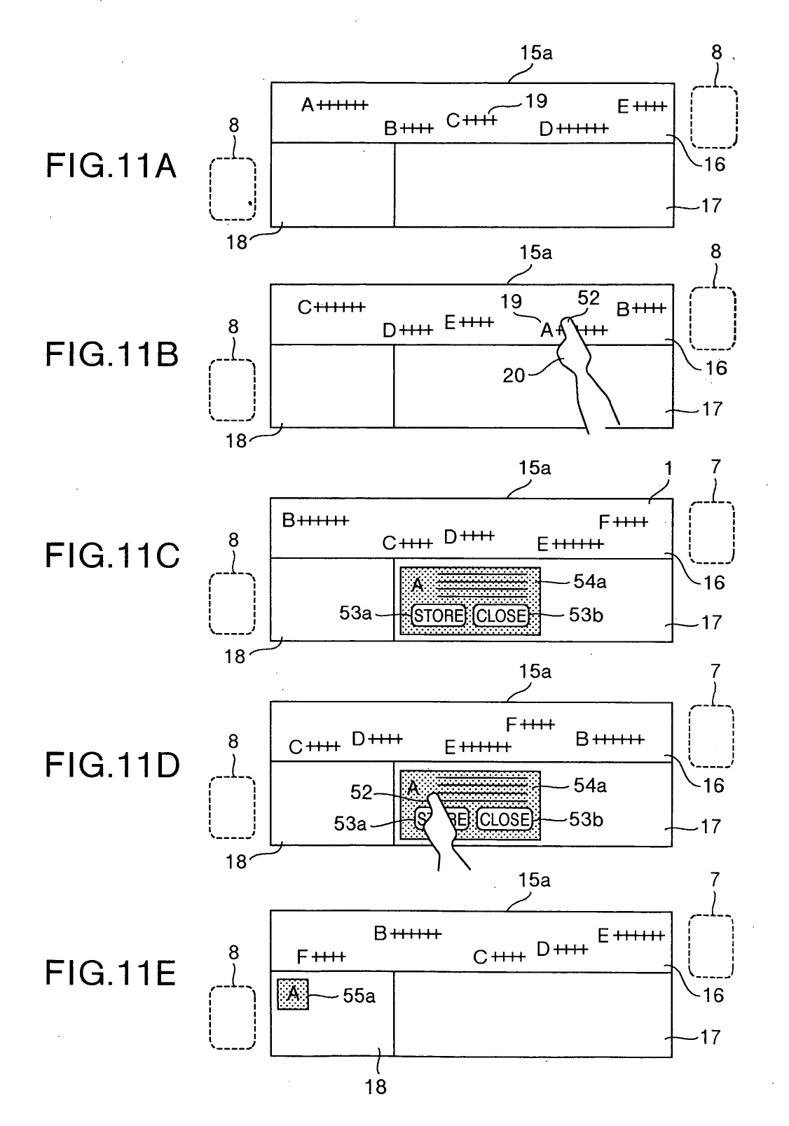

As the keyword 51a in the operation explanation image 51 shown in FIG. 10B is touched, an automatic information operation picture 15a shown in FIG. 11A is displayed. A content list constituted of a plurality of content menus 19 are displayed repetitively in the content list display area 16, flowing in a lateral direction (in the following, it is assumed that the content menu flows (scrolls) from the right to left). In the example shown in FIGS. 11A to 1E, seven contents menus 19 are shown including “A++++”, “B++++”, “C++++”, “D++++”, “E++++”, “F++++” and “G++++”, and the corresponding contents are represented by A, B, C, D, E, F, and G, respectively.

In this display state, as shown in FIG. 11B, one content menu 19 (e.g., “A++++”) in the content list is touched and selected, and the content corresponding to the content menu “A++++” 19 is read from the content database 38 (FIG. 7) of the server 35 in the manner described above. As shown in FIG. 1C, a content picture 54a of the content A is displayed in the content reproduction area 17 of the automatic information operation picture 15a. A “store” button 53a and a “close” button 53b are also displayed in the content reproduction area 17. In the content list display area 16, the selected content menu “A++++” 19 is removed. As the content menu 19 is selected and removed, the new content menu “F++++” 19 is additionally displayed in the content list.

As shown in FIG. 1D, as the “store” button 53a is touched with the pointing member such as a fingertip, as shown in FIG. 11E an icon (content icon) 55a of the content A is displayed in the content storage area 18 and the display of the content picture 54a in the content reproduction area 17 is terminated.

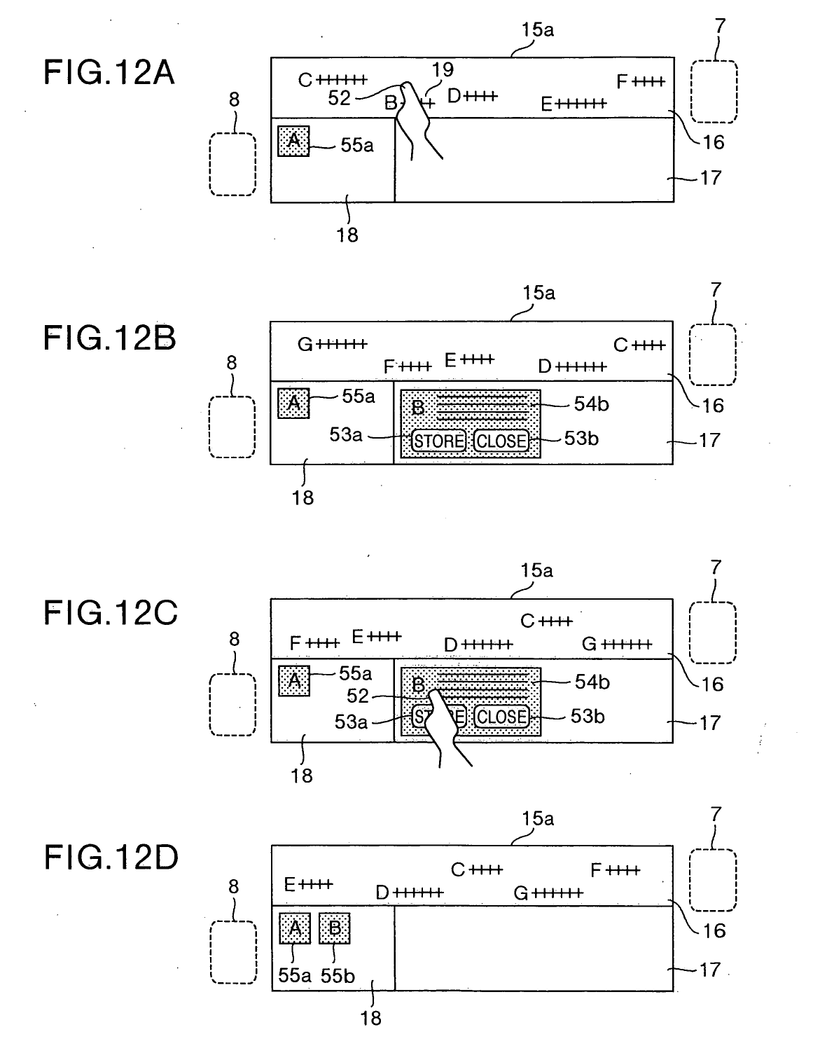

Next, as another content menu “B++++” 19 is touched and selected in the automatic information operation picture 15a shown in FIG. 11E, as shown in FIG. 12A the content B corresponding to the content menu “B++++” 19 is read from the content database 38 (FIG. 7) of the server 35 in the manner described above. As shown in FIG. 12B, a content picture 54b of the content B is displayed in the content reproduction area 17 of the automatic information operation picture 15a. The “store” button 53a and “close” button 53b are also displayed in the content reproduction area 17. In the content list display area 16, the newly selected content menu “B++++” 19 is removed. As the content menu 19 is selected and removed, the new content menu “G++++” 19 is additionally displayed in the content list.

As shown in FIG. 12C, as the “store” button 53a is touched with the pointing member such as a fingertip, as shown in FIG. 12D a content icon 55b of the content B is displayed in the content storage area 18 and the display of the content B in the content reproduction area 17 is terminated. In this case, the content icon “A” 55a remains being displayed, which has already been displayed in the content storage area 18 by the operation illustrated in FIG. 11D.

The content ID's of the contents (contents A and B in FIG. 12D) whose content icons are displayed in the content storage area 18 are stored in the storage unit 32 (FIG. 7) to identify the stored contents. The content whose content ID is stored in the storage unit 32 is called a stored content.

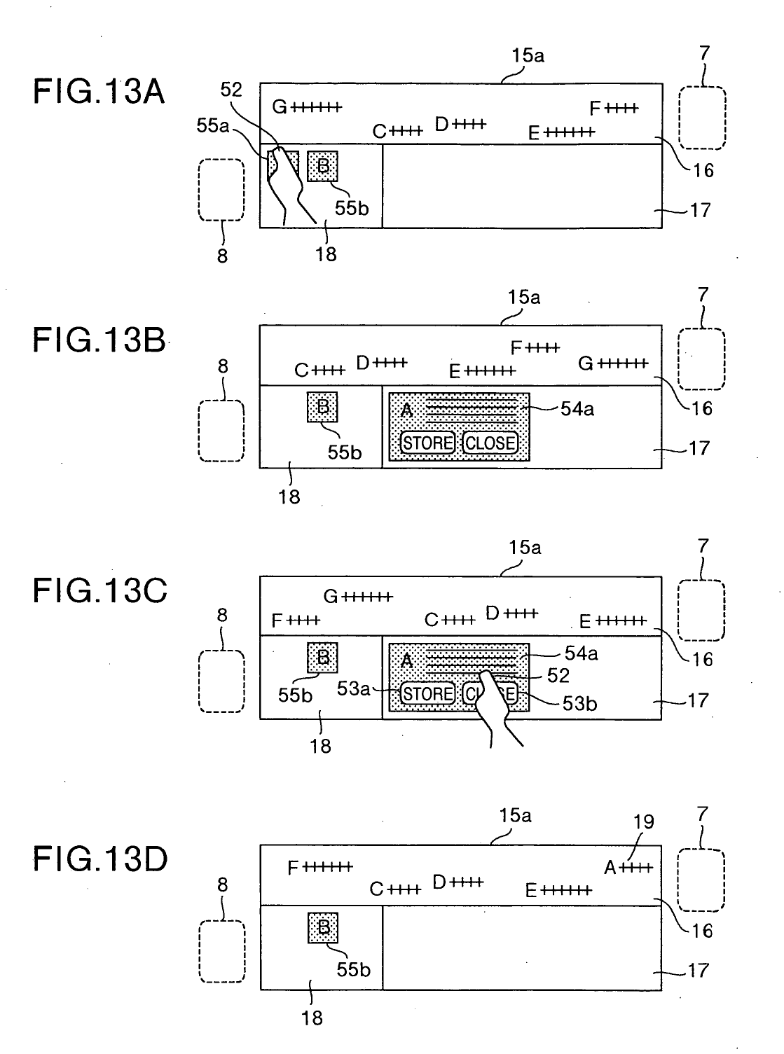

As a content icon, e.g., the content icon “A” 55a, displayed in the content storage area 18 of the automatic information operation picture 15a shown in FIG. 12D is touched and selected with a fingertip 52 as shown in FIG. 13A, the content ID corresponding to the content icon “A” 55a is read from the storage unit 32 (FIG. 7). In accordance with the content ID, the content A is read from the content database 38 of the server 35. As shown in FIG. 13B, a content picture 54a is displayed in the content reproduction area 17, together with the “store button” 53a and “close” button 53b. At the same time, the content ID of the content A is removed from the storage unit 32 and the selected content icon “A” 55a in the content storage area 18 is erased.

In this display state, as the “close” button 53b is touched with the fingertip 52, as shown in FIG. 13D the display of the content picture 54a in the content reproduction area 17 is terminated and at the same time in the content list display area 17, the content menu “A++++” 19 of the content A is added to the content list. At the same time, the content menu 19 (e.g., the lastly added content menu “G++++”) displayed already is removed from the content list.

In this manner, as the content icon displayed in the content storage area 18 is touched, the content corresponding to the content icon is displayed in the content reproduction area 17. Since a user can store the desired content in this manner, the user can reproduce and browse the desired content at any time without any error, instead of selecting it from the content list.

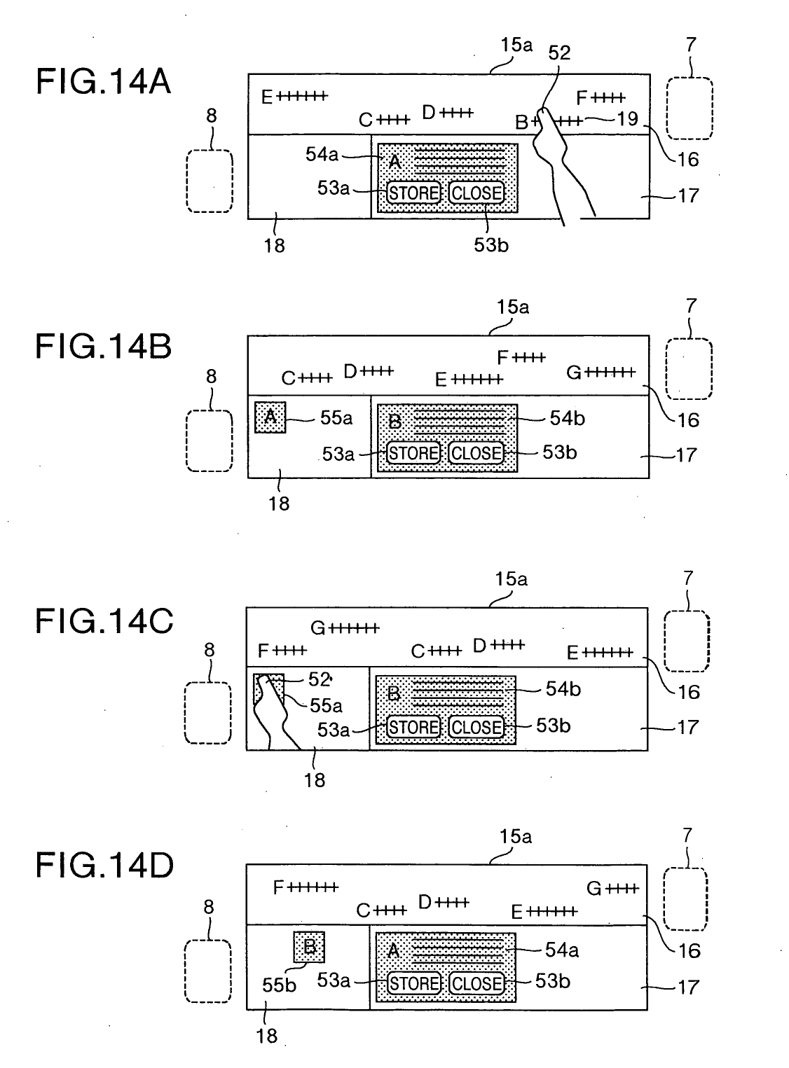

In the automatic information operation picture 15a shown in FIG. 11C displaying the content picture 54a of the content A in the content reproduction area 17, as the content menu 19 (e.g., content menu “B++++”) in the content list display area 16 is selected with the fingertip 52 as shown in FIG. 14A, the content icon “A” 55a of the content A displayed in the content reproduction area 17 is displayed in the content storage area 18 and stored, as shown in FIG. 14B. At the same time, the content picture 54b of the content B corresponding to the selected content menu “B++++” is displayed in the content reproduction area 17, replacing the content picture 54a.

In the automatic information operation picture 15a shown in FIG. 14B, as the content icon “A” 55a in the content storage area 18 is touched with the fingertip 52 as shown in FIG. 14C, the content picture 54a of the stored content A is displayed in the content reproduction area 17 as shown in FIG. 14D, replacing the content picture 54b. At the same time, the content B is stored replacing the content A, and the content menu “B” 55b of the content B is displayed in the content storage area 18.

In this manner, a plurality of stored contents can be browsed at any time through replacement, and the unnecessary stored content can be removed by using the “close” button 53b.

(2) Information Operation Picture 15b for Wireless ID Tag:

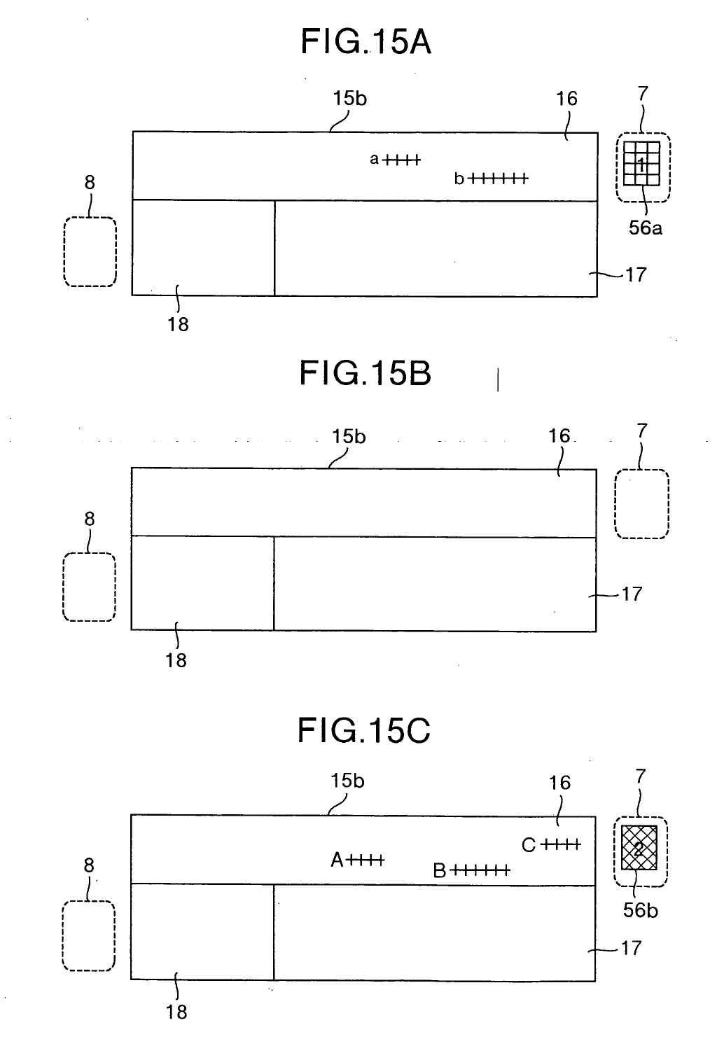

As shown in FIG. 15A, as a wireless ID tag 56a is placed at a position (indicated by a mark, a frame or the like) of the table plane 3 (FIG. 1A) facing the tag sensor 7, the tag sensor 7 reads the pamphlet ID and the information operation picture 15b is displayed in such a manner that the content list of content menus 19 corresponding to the pamphlet ID is displayed flowing in the content list display area 16. In the state that the content menus are displayed, as the wireless ID tag is taken away from the position facing the tag sensor 7, the content menus 19 are not displayed as shown in FIG. 15B. If this state continues for a predetermined time, the automatic information operation picture 15a described with reference to FIGS. 11A to 14D is displayed. However, if the wireless ID tag is placed at the position facing the tag sensor 7 before the lapse of this predetermined time, the content list for the wireless ID tag is displayed as shown in FIG. 15C. If the wireless ID tag 56b is different from the wireless ID tag 56a shown in FIG. 15A, the list of the displayed content list is also different.

Also for the information operation picture 15b, the operations similar to those for the automatic information operation picture 15a described with reference to FIGS. 11A to 14D can be performed. It is therefore possible to browse and store the contents of the content list corresponding to the wireless ID tag.

(3) Information Operation Picture 15c for Wireless IC Card:

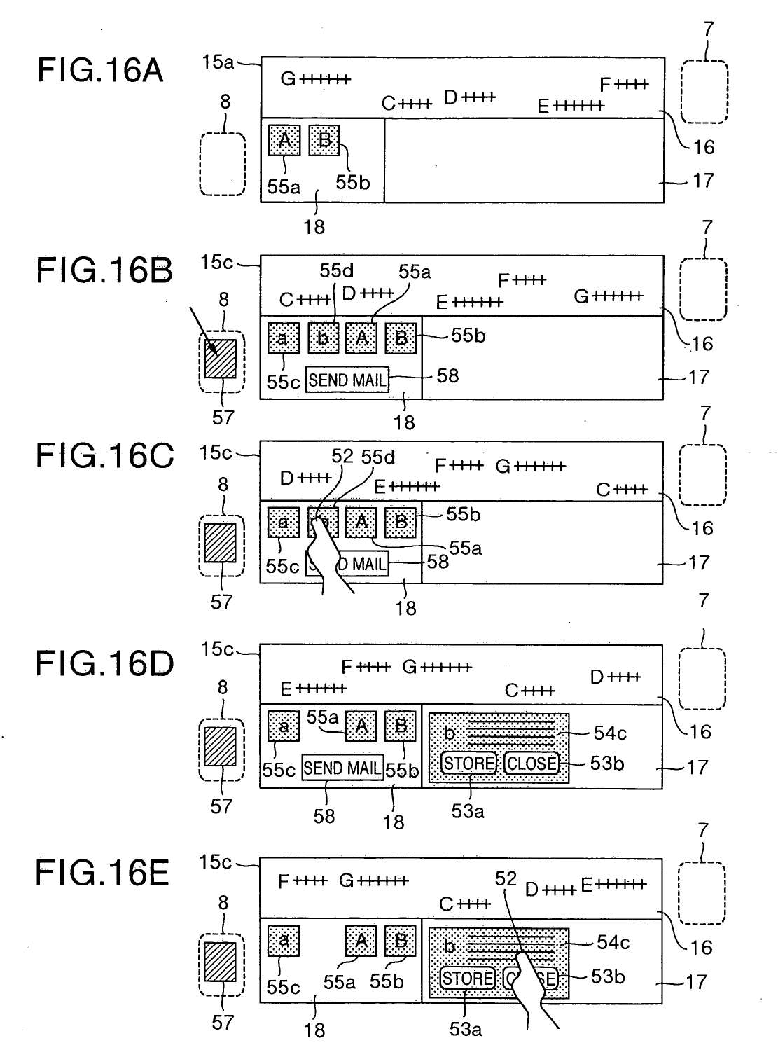

For example, in the display state of the automatic information operation picture 15a shown in FIG. 12D or in the display state of the information operation picture 15b for the wireless ID tag 56 shown in FIG. 16A, as a wireless IC card 57 is placed at a position (indicated by a mark, a frame or the like) of the table plane 3 facing the card reader 8, the card reader 8 reads the user ID of the wireless IC card 57, the content ID's corresponding to the user ID are read from the user database 36 (FIGS. 7 and 8B) of the server 35, and an information operation picture 15c is displayed on the screens 4a and 4b in such a manner that the content icons corresponding to the content ID's are displayed in the content storage area 18. In this example, in addition to the content icons “A” 55a and “B” 55b originally stored, content icons “a” 55c and “b” 55d for the wireless IC card 57 are displayed. A “send mail” button 58 is also displayed in the content storage area 18.

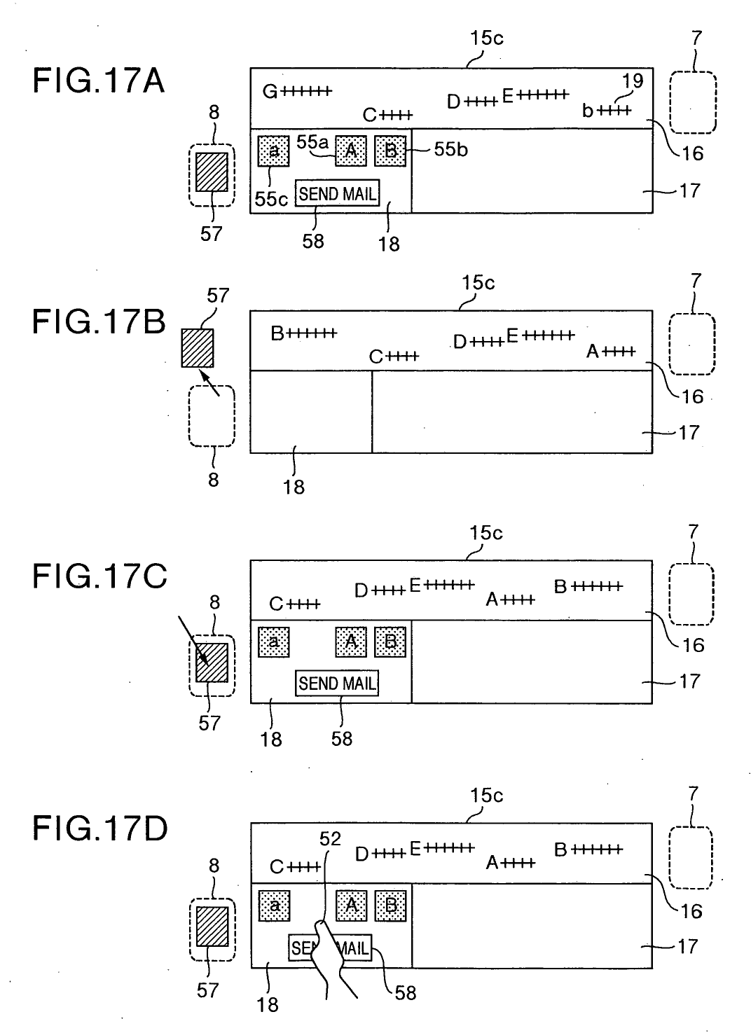

The functions of content icons displayed in the content storage area 18 are all equivalent. As the content icon “b” 55d is selected with the fingertip 52 as shown in FIG. 16C, the content image 54c of the content “b” corresponding to the content icon “b” 55d is displayed in the content reproduction area 17 as shown in FIG. 16D. The content icon “b” 55d is removed from the content storage area 18. At this time, the “store” button 53a and “close” button 53b are also displayed. As the “close” button 53b is touched as shown in FIG. 16E, the content image 54c in the content reproduction area 17 and the buttons 53a and 53b are removed as shown in FIG. 17A, and the content menu “b++++” 19 of the content “b” is additionally displayed in the content list in the content list display area 16.

In this display state, for example, as the wireless IC card 57 is moved away from the position facing the card reader 8, the contents “A”, “B” and “a” corresponding to the content icons “A” 55a, “B” 55b and “a” 55c in the content storage area 18 are registered in the wireless IC card 57 as shown in FIG. 17B. This content registration is performed by registering the content ID's of the contents “A”, “B” and “a” corresponding to the user ID of the wireless IC card 57, in the user database 36 (FIGS. 7 and 8B) of the server 35 (FIG. 7). Therefore, as the wireless IC card 57 is again placed at the position facing the card reader 8, in accordance with the user ID of the wireless IC card 57, the content ID's of the contents “A”, “B” and “a” are read from the user database 36, and the content icons “A” 55a, “B” 55b and “a” 55c of the contents “A”, “B” and “a” are displayed in the content storage area 18 of the information operation picture 15c as shown in FIG. 17C.

For example, as the “send mail” button 58 in the information operation picture 15c for the wireless IC card 57 shown in FIG. 17C is touched as shown in FIG. 17D, the content ID's corresponding to the content icons “A” 55a, “B” 55b and “a” 55c in the content storage area 18 of the information operation picture 15c can be transmitted to PC 42 having the mail address stored in the wireless IC card 57, via the communication unit 34, the external communication unit 40 of the server 35 (the configuration that the external communication 40 is not used may be adopted) and the communication network shown in FIG. 7. PC 42 can write these content ID's in the IC card by using the card reader/writer 43. By using this IC card, PC 42 requests the server for a desired content and the server 35 supplies the requested content from the content database 38 to PC 42.

In the state that the content menu “B++++” 19 of the content “b” for the wireless IC card 57 is displayed in the content list display area 16 as shown in FIG. 17A, as the wireless IC card 57 is moved away from the position facing the card reader 8, the content menu “b++++” 19 is also removed from the content list in the content list display area 16. For example, the content menus “A” and “B” corresponding to the content icons “A” 55a and “B” 55b in the content list of the automatic information operation picture 15a are recovered to the content list in the content list display area 16. The removed content “b” may be browsed by using the wireless ID tag for the content “b” in the manner described above, and at this time, this information can be registered in the wireless IC card.

In this manner, the content capable of being browsed by using a wireless IC card can be changed.

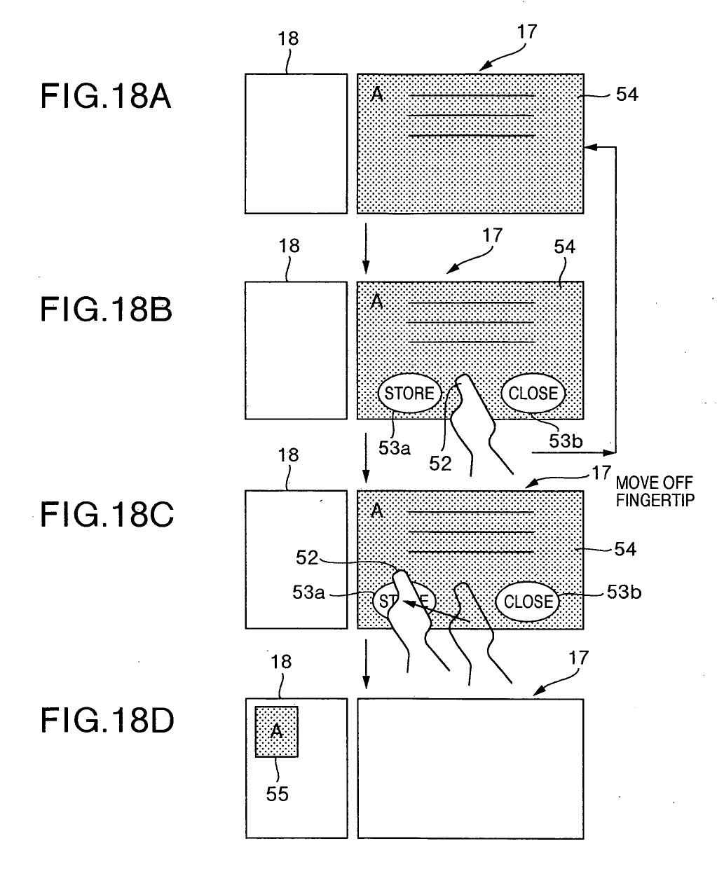

In the above description, the content picture 54, the “store” button 53a and “close” button 53b are displayed at the same time in the content reproduction picture 17 of the information operation picture 15. Instead, the following configuration may be adopted. As shown in FIG. 18A, the “store” button 53a and “close” button 53b are not displayed in the content picture 54, and as the content picture 53a is touched with the fingertip 52 as shown in FIG. 18B, the “store” button 53a and “close” button 53b are displayed and as the fingertip 52 is moved off the content picture, the display state shown in FIG. 18A is recovered. As the touched fingertip 52 is moved to touch the “store” button 53a as shown in FIG. 18C, the content icon 55 is displayed in the content storage area 18 in the manner described earlier and as shown in FIG. 18D.

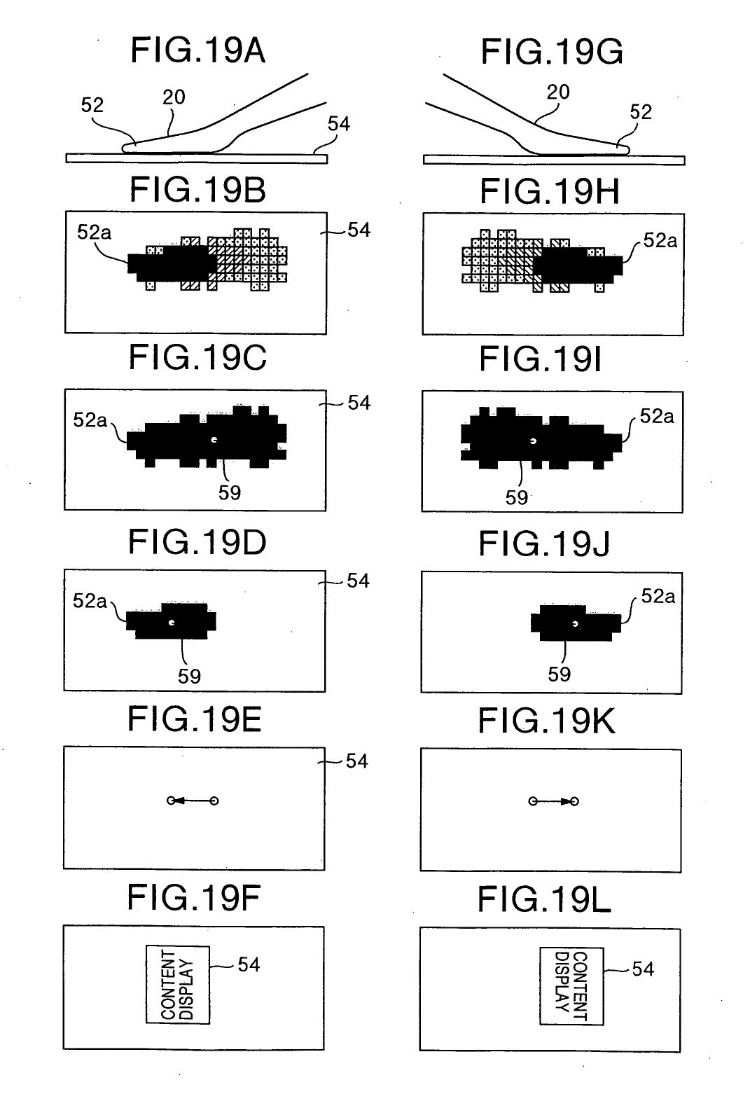

FIGS. 19A to 19L are diagrams illustrating an example of the method of changing the direction of a content picture displayed in the content reproduction area 17 by changing the direction of the pointing member such as a fingertip contacting the content picture.

As shown in FIG. 19A, as the content picture 54 is touched with a fingertip 52 of a hand 20 directed to the left, a silhouette 52a of the fingertip 52 starts appearing as shown in FIG. 19B, and the this elongated silhouette 52a becomes almost maximum as shown in FIG. 19C. At this time, the center 59 of gravity of the silhouette is obtained. Next, as the fingertip moves off the content image 54, a motion of the center of gravity is detected (the intermediate state is shown in FIG. 19D). A motion direction of the center 59 of gravity from when the silhouette 52a becomes maximum shown in FIG. 19C is calculated as shown in FIG. 19E and the content picture 54 is displayed at the position matching the motion direction. As shown in FIG. 19F, the content picture 54 is therefore displayed along the direction of the hand 20, i.e., along the left side direction.

FIGS. 19G to 19L illustrate the case that the direction of the hand 20 is the right side direction. Similar to FIGS. 19A to 19F, the content picture 54 is displayed along the direction of the hand 20, i.e., along the right side direction.

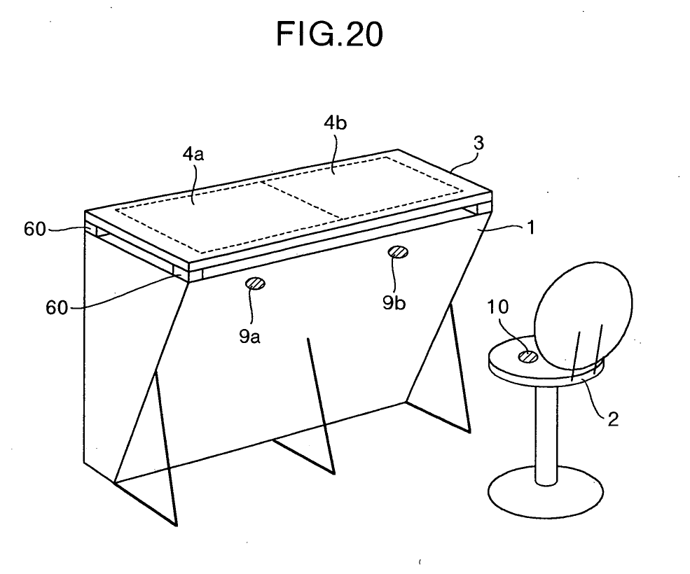

In the first embodiment described above, the infrared LED's 6 shown in FIG. 1A are used to form a silhouette of an object. The invention is not limited only to an infrared LED, but other illumination lamps capable of emitting infrared rays, such as an incandescent lamp, may also be used. In the second embodiment shown in FIG. 20, as a means for detecting the position of an object placed on the table plane 3 of the top board of the table 1, touch sensors such as pressure sensors 60 and electrostatic capacitor sensors may also be used. In this case, the infrared LED's 6, camera units 13a and 13b and video synthesis unit 31 shown in FIG. 7 are not used, but the position of a silhouette of an object on the screens 4a and 4b is detected with the touch sensors 33 shown in FIG. 7.

According to the present invention, as the pointing member such as a fingertip touches a content menu displayed on the table plane, the content corresponding to the selected content menu can be reliably acquired. Even if an object other than the pointing member is placed on the table place, an erroneous content selection can be avoided.

It should be further understood by those skilled in the art that although the foregoing description has been made on embodiments of the invention, the invention is not limited thereto and various changes and modifications may be made without departing from the spirit of the invention and the scope of the appended claims.

1. A table type information terminal comprising:
a control unit;
a screen disposed on a table plane;
a projector unit disposed on one side of said screen for projecting an image on said screen; and
a camera unit disposed on one side of said screen for imaging a silhouette of an object formed on said screen, said object being on another side of said screen,
wherein said control unit judges whether the silhouette imaged with said camera unit is a silhouette of a pointing member for selecting a portion of said projected image or a silhouette of an object other than said pointing member.

2. The table type information terminal according to claim 1, wherein a silhouette of said pointing member is a silhouette of a fingertip, and said control unit judges through pattern recognition whether the silhouette imaged with said camera unit is a silhouette of a pointing member for selecting a portion of said projected image or a silhouette of an object other than said pointing member.

3. The table type information terminal according to claim 1, further comprising a light source on the other side of said screen, and a silhouette imaged with said cameral unit is a silhouette of said pointing member or an object other than said pointing member formed by light emitted from said light source.

4. The table type information terminal according to claim 3, wherein said light source emits light having a predetermined wavelength different from a wavelength of an image projected from said projector unit, and said camera unit received light having said predetermined wavelength.

5. The table type information terminal according to claim 4, wherein said light source is an infrared LED.

6. The table type information terminal according to claim 1, wherein said control unit uses different images to be projected upon said screen from said projector unit, between a case that a silhouette is judged as a silhouette of said pointing member and a case that a silhouette is judged as a silhouette of an object other than said pointing member.

7. The table type information terminal according to claim 1, wherein said projector unit and said camera unit are disposed under the table plane on which said screen is disposed, and said camera unit images a silhouette on said screen of an object on an upper side of said screen.

8. A table type information terminal comprising:
a control unit;
a screen disposed on a table plane;
a projector unit disposed on one side of said screen for projecting an image on said screen; and
a camera unit disposed on one side of said screen for imaging a silhouette of an object formed on said screen, said object being on another side of said screen,
wherein:
said projector unit displays in a scrolling and flowing manner a content list including a plurality of content menus on said screen; and
said control unit judges whether the silhouette imaged with said camera unit is a silhouette of a pointing member for selecting a portion of said projected image or a silhouette of an object other than said pointing member, and if it is judged that the silhouette is the silhouette of the object other than said pointing member, controls a flow of said content list to display said content list to flow by avoiding the object.

9. The table type information terminal according to claim 8, wherein if it is judged that the silhouette is the silhouette of the pointing member, said control unit displays on said screen a content corresponding to a content menu selected from the content list by said pointing member.

10. The table type information terminal according to claim 9, wherein the image projected on said screen includes a content list display area in which said content list is displayed in a scrolling manner and a content reproduction area in which a content corresponding to the selected content menu.

11. The table type information terminal according to claim 10, wherein:
the image projected on said screen further includes a content storage area in which a content icon representative of a stored content is displayed; and
when a content to be displayed in said content reproduction area is to be stored, a content icon of the content is displayed in said content storage area, and when said content icon displayed in said content storage area is selected, a content corresponding to the selected content icon is displayed in said content reproduction area.

12. A table type information terminal comprising:
a control unit;
a screen disposed on a table plane;
a projector unit disposed on one side of said screen for projecting an image on said screen;
a camera unit disposed on one side of said screen for imaging a silhouette of an object formed on said screen, said object being on another side of said screen; and
a tag reader unit for reading an IC tag or a card reader unit for reading an IC card,
wherein:
said control unit makes said projector unit project an image on said screen in accordance with information read from said ID tag with said tag reader unit or information read from said IC card with said card reader unit; and
said control unit judges whether the silhouette imaged with said camera unit is a silhouette of a pointing member for selecting a portion of said projected image or a silhouette of an object other than said pointing member.

13. The table type information terminal according to claim 12, wherein:
said card reader unit reads a mail address from the IC card; and
if it is judged that the silhouette is the silhouette of said pointing member, said control unit transmits a selected image from said projected image to said mail address.
